(19) United States
(12) Patent Application Publication
(10) Pub. No.: US 2026/0070606 A1
(43) Pub. Date: Mar. 12, 2026

(54) ELECTROMECHANICAL STEERING SYSTEM AND METHOD FOR OPERATING AN ELECTROMECHANICAL STEERING SYSTEM WITH REDUCED ENERGY FEEDBACK

(71) Applicants: thyssenkrupp Presta AG, Eschen (LI); thyssenkrupp AG, Essen (DE)

(72) Inventors: Jenoe GYOEKERES, Budapest (HU); Dezsoe BAKOS, Feldkirch (AT); Tamás Gergely KÁROLY, Sennwald (CH)

(73) Assignees: thyssenkrupp Presta AG, Eschen (LI); thyssenkrupp AG, Essen (DE)

(21) Appl. No.: 19/325,329

(22) Filed: Sep. 10, 2025

(30) Foreign Application Priority Data
Sep. 11, 2024 (BE) BE 2024/5613

(51) Int. Cl. B62D 5/04; B62D 5/00

(52) U.S. Cl. CPC B62D 5/046; B62D 5/006; B62D 5/0424

(57) ABSTRACT

A method for operating an electromechanical steering system in a motor vehicle, wherein the steering system includes a first actuator having a first electric motor, comprises operating the first electric motor in a motor mode or a generator mode depending on a driving situation and, in generator mode, actuating the first electric motor in such a way that a generated current is converted energetically by the first electric motor. The first electric motor is controlled by a first control unit by vector control, wherein a d-vector and a q-vector of a rotor-referred d/q system for the first electric motor are influenced by a first controller of the first control unit, and wherein the d-vector for the first electric motor is adapted for the energetic conversion of the generated current. A battery current is provided via a supply line for operation of the first electric motor, wherein a battery current setpoint is defined as the input for the first controller for a generator mode of the first electric motor. An electromechanical steering system comprises a first actuator having a first electric motor and a first control unit, wherein the steering system is designed to be operated according to an aforementioned method.

### CROSS REFERENCE TO RELATED APPLICATION

This application is a U.S. Non-Provisional that claims priority to Belgian Patent Application No. BE 2024/5613, filed Sep. 11, 2024, the entire content of which is incorporated herein by reference.

### FIELD

The present disclosure relates to a method for operating an electromechanical steering system in a motor vehicle.

### BACKGROUND

In the prior art, such a method for a steer-by-wire steering system as an electromechanical steering system and a steer-by-wire steering system having a feedback actuator as the first actuator and a steering actuator as the second actuator are known, for example, from EP 4 273 025 A1.

When an electric motor of an actuator of the steering system is operated in a generator mode, the problem is that electric currents are generated because the DC voltage source and/or the connection to the DC voltage source of an on-board power supply system of a motor vehicle are not suitable or, in the case of newer vehicles that do not include only a classic starter battery (car battery), are no longer suitable for the reception of such generated currents, especially for cost reasons. The generated currents can therefore cause damage to electronics components. Conventional vehicle batteries, which are used, in particular, in motor vehicles with only an internal combustion engine, are thus often suitable for receiving such generated currents. Newer designs of on-board power supply systems with a higher on-board power supply system voltage and provision of the operating voltage via a drive battery in hybrid or electric vehicles require the intermediate connection of a DC/DC converter (DC: direct current), which is not designed to receive or feed back generated currents, especially for cost reasons. This problem is also addressed in DE 10 2021 205 851 A1, wherein, in this document, it is proposed to switch on unnecessary consumers if feedback would cause an overvoltage in the on-board power supply system.

The disadvantage here is that, in this way, operation of an electromechanical steering system in a motor vehicle may depend, in particular, on how an on-board power supply system in a motor vehicle is operated. This disadvantage is countered by the technical teaching according to the generic DE 10 2023 201 346 A1. This document proposes a conversion of the generated electric current in the electric motor of the steering system, wherein an adapted current I_d is generated using field-oriented d/q control.

Thus a need exists to provide an improved method for operating an electromechanical steering system and an improved electromechanical steering system. In particular, the intention is to prevent damage being caused by the generated electric currents in a generator mode of an electric motor of an actuator of the steering system.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified perspective illustration of an exemplary embodiment of an electromechanical steering system designed according to the invention.

FIG. 2 shows a block diagram, depicted in simplified fashion, for explaining an exemplary embodiment of a method for operating an electromechanical steering system, which is designed according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to a method for operating an electromechanical steering system in a motor vehicle, wherein the steering system comprises a first actuator having a first electric motor, wherein the first electric motor is operated in a motor mode or a generator mode depending on the driving situation. In generator mode, the first electric motor is actuated in such a way that a current that is generated in generator mode of the first electric motor is converted energetically by the first electric motor, wherein the first electric motor is controlled by a first control unit by means of vector control, wherein a d-vector having an associated current I_d and a q-vector having an associated current I_q of a rotor-referred d/q system for the first electric motor are influenced by means of a first controller of the first control unit, and wherein the d-vector of the rotor-referred d/q system for the first electric motor is adapted for the energetic conversion of a current that is generated by the first electric motor in generator mode. The first actuator may be, in particular, a feedback actuator or a steering actuator. The invention further relates to an electromechanical steering system, which comprises a first actuator having a first electric motor and having a first control unit, wherein the first electric motor can be operated in a motor mode or a generator mode depending on the driving situation, wherein the first actuator is, in particular, a feedback actuator or a steering actuator.

The proposed solution provides a method for operating an electromechanical steering system, in particular a steer-by-wire steering system, in a motor vehicle, wherein the steering system comprises a first actuator having a first electric motor. The first electric motor is operated in a motor mode or a generator mode depending on the driving situation, wherein, in generator mode, the first electric motor is actuated in such a way that a current that is generated in generator mode of the first electric motor is converted energetically by the first electric motor. In particular, the phase resistance of the motor is used to compensate for the regenerative direct current. The first electric motor is advantageously controlled by a first control unit by means of vector control. The first control unit is, in particular, a control unit assigned to the first actuator, furthermore, in particular, a control unit assigned to the feedback actuator, and may be comprised, in particular, by a so-called power pack. In vector control, a d-vector with an associated current I_d and a q-vector with an associated current I_q of a rotor-referred d/q system for the first electric motor are influenced by means of a first controller of the first control unit, in particular by means of a PID controller of the first control unit. The d-vector of the rotor-referred d/q system and thus the current I_d for the first electric motor is advantageously adapted for the energetic conversion of a current that is generated by the first electric motor in generator mode. Furthermore, provision is made, in particular, for a battery current to be provided via a supply line for operation of the first electric motor, in particular via a DC/DC converter, wherein a battery current setpoint, in particular a minimum battery current setpoint, is defined as the input for the first controller for a generator mode of the first electric motor.

By converting the current directly in the first electric motor, damage caused by the generated currents is advantageously largely avoided. The conversion advantageously remains largely unnoticed by a vehicle user and has no negative effects on the steering behaviour and the steering feeling. The first actuator is, in particular, a feedback actuator of the steering system, which is designed, in particular, to act on a steering handle via a steering shaft. However, the first electric motor may also be, in particular, a steering actuator, which is designed to convert a detected steering specification to a wheel steering angle of steered wheels. The first electric motor is designed, in particular, as a three-phase motor, more particularly as a permanent-magnet synchronous motor.

In particular, the energy for operating the first electric motor is provided via a DC/DC converter, in particular by a drive battery of a motor vehicle. The DC/DC converter ensures provision of the operating voltage required to operate the first electric motor. The DC/DC converter can advantageously be designed in a cost-effective manner because it does not have to be designed to convert or feed back currents that are generated by the first electric motor of the steering system.

For vector control, a mathematical conversion by means of a Clarke transformation and a subsequent Park transformation from a stator-referred three-phase system to the rotor-referred d/q system, in particular, is carried out in a known manner, wherein the d-vector and the q-vector are aligned orthogonally with respect to one another. As is customary in vector control, the q-vector is used to set a torque to be provided, with the d-vector influencing the magnetic flux density.

The d-vector of the rotor-referred d/q system for the first electric motor is adapted, in particular increased, for the energetic conversion of a current that is generated by the first electric motor in generator mode. The d-vector is advantageously adapted in such a way that the generated current is completely or at least almost completely converted. The d-vector and thus the I_d current are adapted, in particular, by means of the controller used for vector control. The q-vector and thus the I_q current remain advantageously unaffected, such that a torque that is perceptible for a vehicle user is not generated by the conversion of the generated currents.

The determination of the battery current setpoint as input for the first controller advantageously specifies a reference value, which the first controller advantageously takes as a basis for the determination of the proportion of the I_d current that is to be adapted. The battery current setpoint is advantageously determined depending on a motor speed of the first electric motor and/or on a motor torque of the first electric motor. The I_d current can thus advantageously be determined particularly suitably by the first controller.

One advantageous development makes provision for a respective battery current setpoint to be defined as the battery current setpoint for specific combinations or for a specific set of combinations of the motor speed and the motor torque. The battery current setpoint can thus advantageously be defined quickly and efficiently for a specific generator mode and the adaptation of the d-vector and thus the determination of the I_d current can thus advantageously be adapted to the specific generator mode in an improved manner.

Ramp values are also advantageously defined between the defined battery current setpoints. The ramp values advantageously contribute to the smoothing of the battery current setpoints. This embodiment is particularly advantageous when only a certain number of reference values for the battery current setpoint are defined as a function of the motor speed and/or the motor torque.

Ramp values are then advantageously defined between the defined battery current setpoints using a ramp function, said ramp values advantageously being valid for the transition between these defined battery current setpoints. This advantageously further contributes to the fact that a steering feeling remains essentially unchanged.

Another advantageous embodiment of the method makes provision for a negative battery current setpoint to be defined in motor mode of the first electric motor. It is thus advantageously ensured that a current I_d that attenuates the magnetic flux density is not set.

According to another advantageous embodiment, a present battery current is calculated, wherein the first controller adapts the current I_d, in particular increases the current I_d, when the calculated battery current is lower than the defined battery current setpoint. It is thus advantageously possible to prevent impairments by currents that are generated by the first electric motor in a more improved manner. The controller furthermore advantageously adapts the current I_d in such a way that the defined battery current setpoint is reached or exceeded.

Another advantageous embodiment makes provision for the first controller to determine a compensation current to adjust the current I_d, wherein the compensation current is advantageously added to a current I_d determined as part of the vector control to form a total current. This procedure is advantageously particularly effective and readily implementable.

A maximum limit value for the total current is also advantageously defined. This limit value for the total current also advantageously limits the torque-forming q-component of the current vector, which has an effect on the steering feeling. The maximum limit value for the total current is advantageously defined so that an effect on the steering feeling is as low as possible, while it is advantageously ensured at the same time that the current I_d is sufficient to keep the feedback current under control.

According to another advantageous embodiment, the present battery current is calculated from voltages U_d and U_q that are applied to d-q voltage outputs of the first controller and the currents I_d and I_q that are fed back as part of the vector control. In particular, the battery current I_B is calculated by I_B=U_d*I_d+U_q*I_q. It is thus advantageously possible to ensure in a further improved manner that a present battery current lies within permissible values and it is also advantageously possible to directly react to a changing battery current.

Another advantageous embodiment of the method makes provision for the first electric motor to be monitored by a first control unit for an occurrence of a generator mode. A generator mode is advantageously identified when a detected motor speed of the first electric motor and a detected motor torque of the first electric motor have opposite signs. This enables reliable identification using existing sensors.

According to another advantageous embodiment, a second electric motor is provided, wherein the second electric motor is actuated in a corresponding manner to the first electric motor. The method steps described above must therefore be carried out in a corresponding manner in addition to the second electric motor. In particular, the first electric motor is an electric motor of a feedback actuator of the steering system and the second electric motor is an electric motor of a steering actuator of the steering system. The steering system advantageously accordingly comprises in addition a second actuator having a second electric motor, wherein the second electric motor is operated in a motor mode or a generator mode depending on the driving situation. The second electric motor is advantageously controlled by a second control unit by means of vector control, wherein a d-vector having an associated current I_d and a q-vector having an associated current I_q of a rotor-referred d/q system for the second electric motor are advantageously influenced by means of a second controller of the second control unit, wherein the d-vector of the rotor-referred d/q system for the second electric motor is adapted for the energetic conversion of a current that is generated by the second electric motor in generator mode.

In order to solve the problem mentioned at the outset, an electromechanical steering system, in particular a steer-by-wire steering system, is also proposed, which comprises a first actuator having a first electric motor and a first control unit, wherein the first electric motor can be operated in a motor mode or a generator mode depending on the driving situation, wherein the first actuator is, in particular, a feedback actuator or a steering actuator, and wherein the steering system is designed to be operated according to a method configured according to the invention.

The features and advantages explained in connection with the method described also apply accordingly to the proposed steering system.

In the various figures, identical parts are generally provided with the same reference signs and are therefore also, in some cases, each explained only in conjunction with one of the figures.

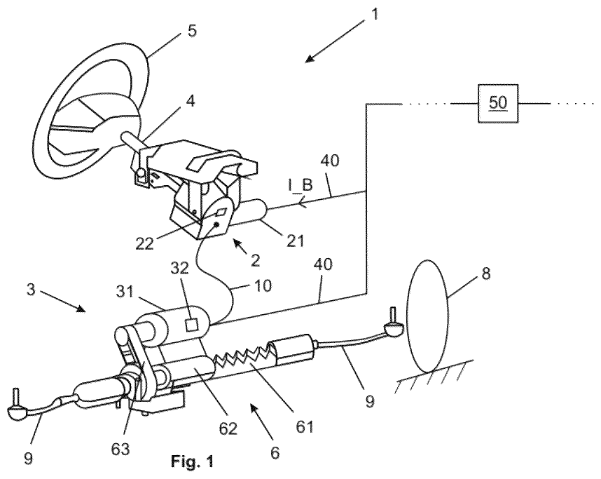

FIG. 1 depicts in a simplified manner an exemplary embodiment of an electromechanical steering system 1 which is designed according to the invention and is designed as a steer-by-wire steering system in this exemplary embodiment. The steering system 1 comprises a first actuator 2 having a first electric motor 21 and having a first control unit 22. The steering system 1 also comprises a second actuator 3 having a second electric motor 31 and having a second control unit 32. In this exemplary embodiment, the first actuator 2 is a feedback actuator acting via a steering shaft 4 of the steering system 1 on a steering handle 5 connected to the steering shaft 4 in a rotationally fixed manner and the first electric motor 21 is a feedback actuator electric motor. In this exemplary embodiment, the second actuator 3 of the steering system 1 is a steering actuator acting via a steering gear 6 on steerable wheels 8 of the motor vehicle and the second electric motor 31 is a steering actuator electric motor. Both electric motors 21, 31 are three-phase motors, in particular permanent-magnet synchronous motors.

The first electric motor 21 is operated in a motor mode depending on the driving situation, in particular for generating an active counter-steering action against a steering input applied by a driver to the steering handle 5, or operated in a generator mode, in particular when a certain steering resistance is displayed towards a steering movement applied by a driver. The first actuator 2 having the first electric motor 21 is thus designed, in particular, to exert a torque or a steering resistance torque on the steering shaft 4, in particular for conveying a steering feeling that is perceptible for a driver of a motor vehicle.

The second electric motor 31 can also be operated in principle in a motor mode and a generator mode, wherein a generator mode rarely arises, for example when a different wheel steering angle is forced on the steerable wheels 8 from the outside due to an obstacle. A motor mode of the second electric motor 31 is required in this case particularly when a detected steering specification, in particular a steering movement applied by a driver via the steering handle 5, must be converted to a corresponding wheel steering angle of the steered wheels 8. In order to convert a steering specification to a wheel steering angle of the steerable wheels 8, the second actuator 3 acts via the steering gear 6 on the steerable wheels 8.

Specifically, in this exemplary embodiment, provision is made for the second electric motor 31 of the second actuator 3 to act via a transmission belt 63 on a spindle drive 62, which is operatively connected to a coupling rod 61 formed as a rack. Appropriate actuation of the second electric motor 31 drives the spindle drive 62 for converting a steering specification to a steering movement of the steerable wheels 8. In this case, the second actuator acts via the spindle drive 62, which is driven by the second electric motor 31, on the coupling rod 61 and thus triggers a steering movement of the steerable wheels 8 of a motor vehicle, wherein the steerable wheels 8 in this exemplary embodiment are connected in a known manner to the coupling rod 61 via track rods 9. The track rods 9 themselves are each connected to one steered wheel 8 in a known manner via steering knuckles.

The first electric motor 21 and the second electric motor 31 of the steering system 1 are connected via a DC/DC converter 50 to an on-board power supply system of a motor vehicle, wherein the energy required for a motor mode of the electric motors 21, 31 is provided via the DC/DC converter 50 and appropriate supply lines 40.

The first electric motor 21 and the second electric motor 31 are respectively actuated based on vector control by means of the control units 22, 32 assigned to the electric motors 21, 31. For this purpose, the stator-referred three-phase system is transformed in a known manner to a rotor-referred d/q system, which is carried out using a Clarke transformation with subsequent Park transformation. The d-vector and q-vector thus obtained for the control of the respective electric motor 21, 31 are then adapted accordingly by means of a PID controller included in the respective control unit 22, 32 in order to implement a control specification. As usual, the torque to be provided by the respective electric motor 21, 32 is controlled by an adjustment of the q-value, while the d-value has an influence on the magnetic flux density.

In this exemplary embodiment, the first electric motor 21 is controlled in a generator mode by the first control unit 22 by means of the first PID controller included in the first control unit 22 in such a way that a current that is generated in the generator mode of the first electric motor 21 is converted energetically by the first electric motor 21. In this exemplary embodiment, the second electric motor 31 is actuated by the second control unit 32 by means of the second PID controller included in the second control unit 32 in principle in the same manner as the first electric motor 21 in a generator mode of the second electric motor 31 for the conversion of currents that are generated in this generator mode in such a way that a current that is generated in the generator mode of the second electric motor 31 is converted energetically by the second electric motor 31. Only the actuation of the first electric motor 21 in a generator mode is therefore explained in more detail for this exemplary embodiment because a corresponding actuation is also advantageously provided for the second electric motor 31 in the same manner. In another embodiment, however, provision may also be made, in particular, to actuate the second electric motor 31 in a different manner to the actuation of the first electric motor 21.

If the first electric motor 21 is now operated in a generator mode, the first electric motor 21 is actuated by the PID controller of the first control unit 22 in such a way that the I_d current specified as part of vector control for the first electric motor 21 is adapted, in particular is increased, this being carried out by appropriate adaptation of the d-vector, as a result of which the current that is generated in the generator mode of the first electric motor 21 is converted energetically by the first electric motor 21. As a result of the fact that only the d-vector, but not the q-vector, is adapted, the generated current advantageously has no influence on the behaviour of the first electric motor 21 that is perceptible by a vehicle user during steering. The current that is generated by the first electric motor 21 is thus advantageously “combusted” in the first electric motor 21 and thus advantageously does not load the DC/DC converter 50 and not the on-board power supply system either. In order to adapt the d-vector and thus the current I_d appropriately, a battery current setpoint is defined as the input value for the PID controller for a generator mode of the first electric motor 21.

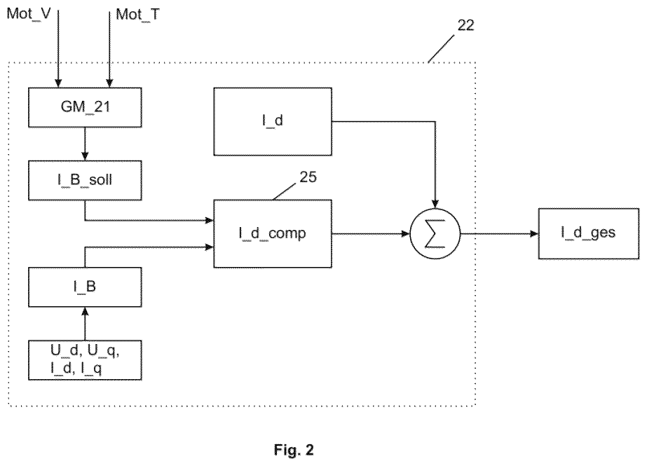

An advantageous embodiment of a method for operating an electromechanical steering system 1 in a motor vehicle, in particular the steer-by-wire steering system 1 shown in FIG. 1, wherein the steering system 1 comprises a first actuator 2 having a first electric motor 21, and the first electric motor 21 is operated in a motor mode or a generator mode GM_21 depending on the driving situation, wherein the first electric motor 21 in generator mode GM_21 is actuated in such a way that a current that is generated in generator mode GM_21 of the first electric motor 21 is converted energetically by the first electric motor 21, is explained in more detail with reference to FIG. 2.

A battery current I_B is provided to the first electric motor 21 via a supply line 40 for the operation of the steering system 1. As already explained, the first electric motor 21 is controlled by the first control unit 22 by means of vector control. For the first electric motor 21, the d-vector with an assigned current I_d and the q-vector with an assigned current I_q of the rotor-referred d/q system are influenced by means of the PID controller of the first control unit 22 in accordance with the requirements detected and the respective associated mode (motor mode or generator mode). In this case, in a generator mode GM_21 of the first electric motor 21 for the energetic conversion of a current that is generated by the first electric motor 21, the d-vector of the rotor-referred d/q system for the first electric motor 21 and thus the current I_d are adapted in such a way that the generated current does not load the on-board power supply system.

A generator mode GM_21 of the first electric motor 21 is identified when a detected motor speed Mot_V of the first electric motor 21 and a detected motor torque Mot_T of the first electric motor 21 have opposite signs. If a generator mode GM_21 is identified, a battery current setpoint I_B_soll is defined as the input for the PID controller 25 of the first control unit 22. The definition of the battery current setpoint I_B_soll depends here on a detected motor speed Mot_V of the first electric motor 21 and on a detected motor torque Mot_T of the first electric motor 21. The battery current setpoint I_B_soll is thus defined differently for different motor speeds Mot_V and different motor torques Mot_T as well as different combinations thereof, wherein ramp values are advantageously defined between the defined battery current setpoints I_B_soll for current smoothing, which ramp values are extrapolated, in particular, between two defined battery current setpoints.

A present battery current I_B is determined here by the control unit 22. In this exemplary embodiment, to this end, voltages U_d and U_q currently applied to the d-q voltage outputs of the PID controller 25 are detected and the present battery current I_B is calculated taking into account these voltages U_d and U_q and the currents I_d and I_q that are fed back as part of the vector control. The PID controller 25 of the first control unit 22 in this case adapts a current I_d determined as part of the vector control when the calculated battery current I_B is lower than the defined battery current setpoint I_B_soll. In order to reliably prevent, in a motor mode of the first electric motor 21, a current I_d that influences the magnetic flux density from being adapted incorrectly, a negative battery current setpoint I_B_soll is advantageously defined in a motor mode of the first electric motor 21.

If, in a generator mode GM_21, the calculated battery current I_B is lower than the defined battery current setpoint I_B_soll, the current I_d determined by the vector control is adjusted using the PID controller 25 in such a way that the defined battery current setpoint I_B_soll is reached.

To adapt the current I_d determined by the vector control, a compensation current I_d_comp is determined by means of the PID controller 25, wherein the compensation current I_d_comp is added to the current I_d determined as part of the vector control to form a total current I_d_ges that influences the magnetic flux density. Since this total current I_d_ges cannot become arbitrarily large, provision is made in this exemplary embodiment for a maximum limit value for the total current I_d_ges to be defined, with this being selected in such a way that a steering feeling always remains essentially unchanged for a vehicle user during operation of the steering system 1.

The exemplary embodiments illustrated in the figures and explained in conjunction therewith serve to explain the invention and have no limiting effect thereon.

### LIST OF REFERENCE SIGNS

1 Steering system
2 First actuator
21 First electric motor
22 First control unit
25 First controller (PI controller)
3 Second actuator
31 Second electric motor
32 Second control unit
4 Steering shaft
5 Steering handle
6 Steering gear
61 Coupling rod (rack)
62 Spindle drive
63 Transmission belt
8 Steerable wheel
9 Track rod
10 Signal line
40 Supply line
50 DC/DC converter
GM_21 Generator mode
Mot_V Motor speed
Mot_T Motor torque
I_B Battery current
I_B_soll Battery current setpoint
I_d Vector control current that influences the magnetic flux density
I_q Vector control current that influences the torque of the electric motor
I_d_comp Determined proportion of the current I_d for converting a current that is generated in generator mode
I_d_ges Resulting total current that influences the magnetic flux density
U_d Voltage applied to d-voltage output of the first controller (25)
U_q Voltage applied to q-voltage output of the first controller (25)

1. A method for operating an electromechanical steering system in a motor vehicle, wherein the steering system includes a first actuator having a first electric motor, the method comprising:
operating the first electric motor in a motor mode or a generator mode depending on a driving situation;
wherein, in generator mode, the first electric motor is actuated in such a way that a current that is generated in generator mode of the first electric motor is converted energetically by the first electric motor;
wherein the first electric motor is controlled by a first control unit by vector control;
wherein a d-vector having an associated current I_d and a q-vector having an associated current I_q of a rotor-referred d/q system for the first electric motor are influenced by a first controller of the first control unit;
wherein the d-vector of the rotor-referred d/q system for the first electric motor is adapted for the energetic conversion of a current that is generated by the first electric motor in generator mode;
wherein a battery current is provided via a supply line for operation of the first electric motor;
wherein a battery current setpoint is defined as the input for the first controller for a generator mode of the first electric motor.

2. The method according to claim 1, wherein the battery current setpoint is defined by a motor speed of the first electric motor.

3. The method according to claim 2, wherein the battery current setpoint is defined depending on a motor torque of the first electric motor.

4. The method according to claim 3, wherein a respective battery current setpoint is defined as the battery current setpoint for specific combinations or for a specific set of combinations of the motor speed and the motor torque.

5. The method according to claim 4, wherein ramp values are defined between the defined battery current setpoints.

6. The method according to claim 1, wherein a negative battery current setpoint is defined in the motor mode of the first electric motor.

7. The method according to claim 1, wherein the present battery current is calculated, wherein the first controller adapts the current I_d when the calculated battery current is lower than the defined battery current setpoint.

8. The method according to claim 7, wherein the first controller adapts the current I_d in such a way that the defined battery current setpoint is reached or exceeded.

9. The method according to claim 8, wherein the first controller determines a compensation current to adjust the current I_d, wherein the compensation current is added to a current I_d determined as part of the vector control to form a total current.

10. The method according to claim 9, wherein a maximum limit value is defined for the total current.

11. The method according to claim 10, wherein the present battery current is calculated from voltages U_d and U_q that are applied to d-q voltage outputs of the first controller and from the currents I_d and I_q that are fed back as part of the vector control.

12. The method according to claim 1, wherein a generator mode is identified when a detected motor speed of the first electric motor and a detected motor torque of the first electric motor have opposite signs.

13. The method according to claim 1, further comprising a second electric motor, wherein the second electric motor is actuated in a corresponding manner to the first electric motor.

14. An electromechanical steering system, comprising:
a first actuator having a first electric motor and a first control unit;
wherein the first electric motor can be operated in a motor mode or a generator mode depending on a driving situation;
wherein the steering system is designed to be operated according to the method of claim 1.
